(19) United States
(12) Patent Application Publication
(10) Pub. No.: US 2002/0161710 A1
(43) Pub. Date: Oct. 31, 2002

(54) Document, document processing system and document generating system

(75) Inventor: Naohiro Furukawa, Hachioji (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 10/014,412

(22) Filed: Dec. 14, 2001

(30) Foreign Application Priority Data
Apr. 25, 2001 (JP) 2001-127654

(51) Int. Cl. G06F 17/60

(52) U.S. Cl. 705/51

(57) ABSTRACT

In printing a document, such items of document processing information as the document form, the processing method, and the format are embedded in the document to be extracted and used in document processing. In document preprinting, document processing information regarding the document form is embedded onto the document. In printing the document contents, the document processing information embedded in the document is extracted such that the contents are printed according to the document processing information. This allows a document processing system to use accurate document processing information even if the document forms to be handled vary widely. It also keeps the accuracy of document processing when the same document form is printed by another printing office at a different time.

### BACKGROUND OF THE INVENTION

1. Field of the Invention

The present invention relates to a document, especially a bill/commercial paper, a document processing system, a document generating system, a document printing system, a document processing method, a document generating method, and a document printing method; for reading such information stated on a document as a sum of money and the name of the payer, for processing the document, and especially for facilitating the management of document processing information.

2. Description of Related Art

A document processing system is generally known as a system for reading such documents as transfer chits and tax payment chits with an optical scanner and then reading from the resulted image data such information as the sums of money and the names of payers stated on the documents.

The document processing system needs to know document processing information on characteristics and documents handling methods in advance so as to process documents appropriately and accurately.

This document processing information comprises, for instance,:

(1) Document form information

Document form ID

Document issuer's name

Document issuer's account number

(2) Layout information

Rule mark positions

Frame position

Frame attributes (box for sum, box for date, etc.)

Character types in frame (numerals, Chinese characters, Japanese phonetic letters, etc.)

(3) Application information

Document handling procedure

Document cutting position

Acknowledging seal position

In order to realize highly accurate document processing, it is important to prepare and manage document processing information.

The prior art techniques for preparing the aforementioned document processing information include the one described in JP-A-2000-172779. This prior art technique uses an optical character reader to automatically extract a field frame from an input image of the document of the object of document processing information preparation, to determine an effective field frame by utilizing a pre-registered field frame, and to prepare the layout information, which is one aspect of document processing information. Another prior art technique for preparing document processing information is described in JP-A-11-184965. This prior art technique extracts only document processing information for distinguishing document forms by automatically extracting at least one image constituent element satisfying the conditions of character pattern among other factors.

Prior art techniques regarding the management of documents of different characteristics, such as font, include the one described in JP-A-9-73502. This technique relates to a method for classifying/storing documents in a database. According to this technique, a plurality of document classification devices are linked with a network, of which only one document classification device is processing one specific document, and the result is transmitted to other document classification devices via the network.

Techniques regarding the overall configuration of a document classification system include those processing document images via a network as disclosed in JP-A-7-114616 and JP-A011-167603.

However, none of the prior art techniques cited above provides advance preparation of document processing information, such as document forms, to be embedded in the document so as to be transmitted with the document. For this reason, these techniques experience extreme difficulty to prepare in advance and store document processing information on diverse document forms or formats. In Japan, the Japanese financial institutions handle tens of thousands of different types of document forms.

In practice, the layout and handling method of documents are changed frequently. Even the same document form may differ in printed fonts and character string positions if the printing office or the timing of printing differ. These techniques involve another problem that the accuracy of document processing deteriorates when such differences occur.

### SUMMARY OF THE INVENTION

The present invention aims to solve the problems of the prior art and to provide a document, a document processing system and software, a document generating system and software, a document printing system and software, a document processing method, a document generating method, and a document printing method; for allowing the system to use accurate document processing information even if document forms to be handled has wide variety, and for keeping documents to be accurately handled even in a case where the same document form is printed by a different printing office and/or at a different timing.

The objects is achieved by a method of the invention for providing a document along with document processing information thereby processing the document according to the document processing information by embedding the document processing information in the document.

According to the invention, the object is achieved by having a document for use in bill payment containing in itself document processing information needed for processing the document.

The object is also achieved with a document processing system includes an image input apparatus for reading a document image, a document processing apparatus for executing a document handling procedure in accordance with document processing information, and a document processing information extracting means for extracting document processing information stored in advance on an entered document.

The object is further achieved by providing a document generating software which comprises a communication module for a prospective document user wishing to have a document made to notify a document generator of requirements regarding the document layout and the document handling procedure, a document layout making module for making a document layout according to the requirements from the user, a document candidate presenting module for presenting to the user document candidates made by the document layout making module, a document selecting module for the prospective document user to select a document layout from the document candidates presented by the document candidate presenting module, and a document processing information storing module for the document generator to store document processing information onto the selected document candidate itself.

The object is further achieved with a document printing system includes a document preprinting means for printing common rule marks and character strings in the same document form, a document printing means for printing rule marks and character strings different from the document form, a document processing information storing means for storing, at the time of document preprinting, document processing information on the document form onto the document itself, a document processing information extracting means for extracting, at the time of printing document contents, document processing information stored in advance on the preprinted document itself, and a document printing means for printing document contents in accordance with the document processing information.

Other and further objects, features and advantages of the invention will appear more fully from the following description.

### BRIEF DESCRIPTION OF THE DRAWINGS

The preferred embodiments of the present invention are illustrated in the accompanying drawings in which:

FIG. 1 is a block diagram illustrating a document processing system in a first embodiment for implementing the present invention;

FIG. 2 shows an example document used in the first embodiment for implementing the invention;

FIG. 3 is a general flow chart showing the processing in the first embodiment for implementing the invention;

FIG. 4 is a detailed flow chart showing details for providing the document generating service of FIG. 3;

FIG. 5 is a flow chart of document processing in a document processing system within a financial institution according to the invention;

FIG. 6 is a flow chart for a financial institution to request a document issuer to pay a charge for document processing according to the invention;

FIG. 7 illustrates a typical format of a bill;

FIG. 8 is a block diagram illustrating a document processing system of the second embodiment for implementing the invention;

FIG. 9 illustrates an example of a preprinted document; and

FIG. 10 is a flow chart for printing the documents according to the invention.

### DETAILED DESCRIPTION OF THE PREFERRED EMBODIMENTS

The preferred embodiments of the present invention constituting a document processing system and a document generating service are described in detail below with reference to the accompanying drawings.

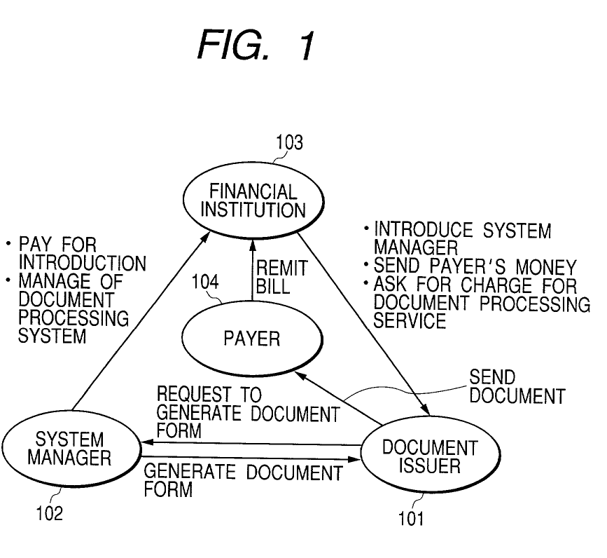

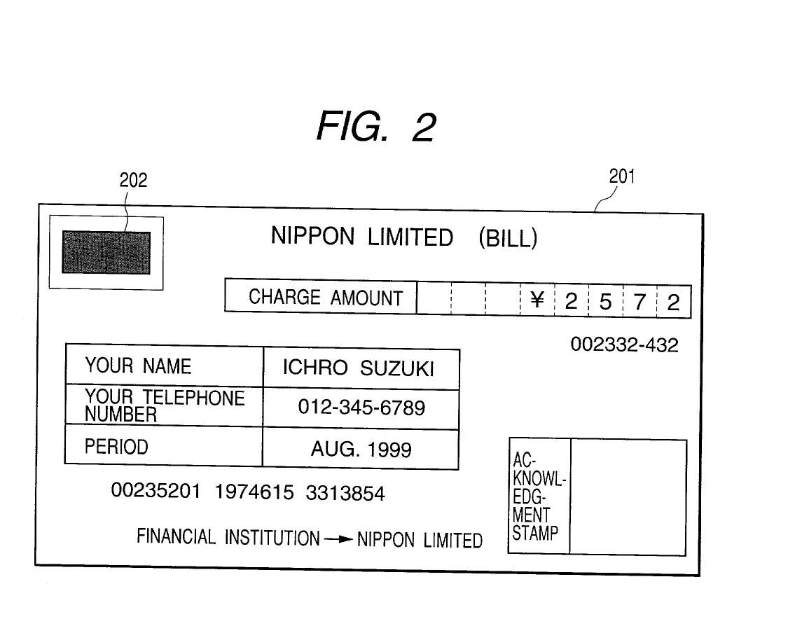

FIG. 1 is a block diagram illustrating a document processing system of the first embodiment for implementing the invention, and FIG. 2 shows an example document used in the first embodiment for implementing the invention. First, referring to FIG. 1, parties involved in the system according to the invention, system configuration and various functions are described in detail. In FIG. 1, reference numeral 101 denotes a document issuer, 102 denotes a document system manager, 103 denotes a financial institution, 104 denotes a financial institution's client, such as a payer, 201 denotes a document, and 202 denotes a two-dimensional bar code or other medium which embeds or encodes a document processing information.

The first embodiment for implementing the invention, as shown in FIG. 1, requires as the parties concerned a document issuance, namely, an issuer 101, a document system manager 102, a financial institution 103 actually processing the documents, and a financial institution's client 104 will have/receive a document to be processed. One of these parties, such as the financial institution 103, is provided with a document processing system having an image input apparatus and a document processing apparatus for processing the documents, while the document system manager 102 is provided with a document generating/printing system for making and printing documents and a document processing system managing means for managing the document processing system of the financial institution 103. The documents can be transmitted through paper delivery, a communication medium, or a telecommunication medium.

The document issuer 101, e.g., a local government wishing to collect taxes, a utility power company wishing to collect electricity bills, or a communication company wishing to collect communication service bills, sends a document to a financial institution's client 104 for whom payments will become due.

The financial institution's client 104, receiving a document issued by the document issuer 101 with a format illustrated in FIG. 2, goes to the financial institution 103 to fulfill the obligation, i.e. to pay the bill or execute a commercial paper as stated therein so as to receive a certificate acknowledging the payment, in accordance with the document processing of the invention.

The financial institution 103, e.g., a bank, a post office, a convenience store, or a collecting agent, is an entity accepting various such documents. The documents accepted are processed in accordance with the procedure for each type of document and sent with the pertinent remittances to their respective issuers.

The document issuer 101 requests the document system manager 102 to generate a document. The document system manager 102 generates the document in compliance with the request of the document issuer 101. The document system manager 102 provides the document processing system via hardware, software, or on-line support to the financial institution 103 and also takes charge of its management.

A document for use in the invention, as illustrated in FIG. 2, has a format in which various items of document processing information, including the document form, the processing procedure, the processing method and the format of the document 201 are encoded into the two-dimensional bar code 202 and stated in a prescribed position, such as a corner of the document. In particular, the document handling procedure may be a document cutting step in conjunction with a document cutting position, a seal stamping step in conjunction with a seal stamping position, a document identification step in conjunction with a document ID, a document format identification step in conjunction with a document format ID, an encryption step in conjunction with a encryption key, or a decryption step in conjunction with a decryption key. The available means by which document processing information is stored on the document include, in addition to the two-dimensional bar code form shown in FIG. 2:

(1) Text form;

(2) One-dimensional, 2D or 3D bar code form;

(3) Magnetic tape;

(4) IC chip; and

(5) Printing in an encoded form into a logo mark, photograph or some other graphic item, such as a watermark, photograph, holographic.

While the invention may use any of these storage means transported along with the document, the embodiment described hereinafter is supposed to use the two-dimensional bar code form.

Incidentally, the use of the two-dimensional bar code provides such features as:

(a) Capability to store kilobytes of document processing information;

(b) Higher accuracy in extracting the financial information than the text form;

(c) Greater ease in detecting the position than the text form; and

(d) A lower cost for generating documents generating and for the reading device than an existing magnetic tape or IC chip.

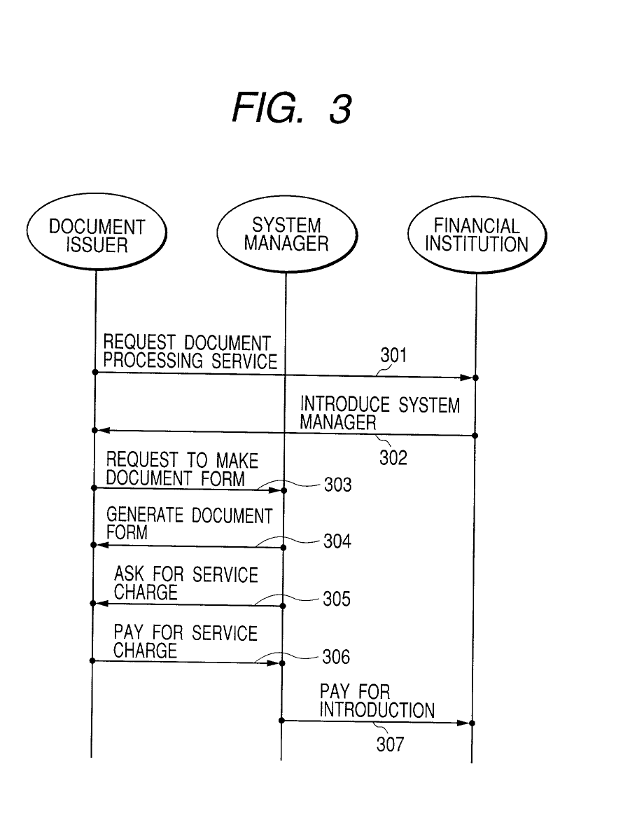

FIG. 3 is a general flow chart showing the processing in the first embodiment for implementing the invention. The following description refers to this diagram.

(1) First, the document issuer 101 notifies the financial institution 103 of its wish to have a document, especially a bill/commercial paper, handled (step 301).

(2) Notified of the wish to have the document handled, the financial institution 103 introduces to the document issuer 101 the document processing system manager 102 for generating the document generator (step 302).

(3) The document issuer 101 requests the introduced document processing system manager 102 to generate the document, and the document processing system manager 102 generates the document as desired. A detailed procedure of this document generating service will be described afterwards (steps 303 and 304).

(4) The document processing system manager 102 bills the document issuer 101 for generating the document, and the document issuer 101 pays the document processing system manager 102 for the document generating (steps 305 and 306).

(5) Also, after the aforementioned arrangement for the document generating service is accomplished, the document processing system manager 102 pays a commission for the introduction to the financial institution 103 (step 307).

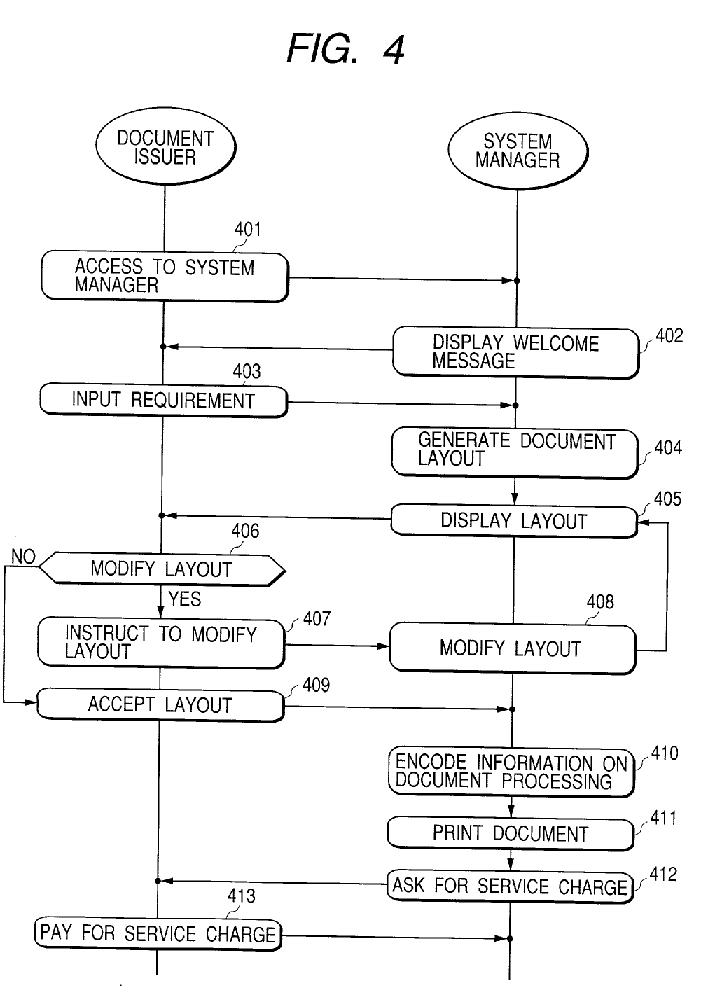

FIG. 4 is a detailed flow chart showing the details for providing the document generating service described above. The following description refers to this chart. As the means of communication between the document issuer 101 and the document processing system manager 102, a network, such as the Internet, a telephone, a facsimile, a mailed hard copy, or a face-to-face dialogue may be used. This embodiment uses a network. The document processing system manager 102 has a website available for access thereby providing the document generating service. The processing procedure to be described below can be similarly applied to other means of communication as well.

(1) First, the document issuer 101 accesses the web site of the document processing system manager 102 from its own terminal device. The document processing system manager 102, in response to this access, transmits an input screen to the document issuer 101. This results in displaying of a screen on which the required items are to be entered by the document issuer 101 (steps 401 and 402).

(2) The document issuer 101 enters its name, the title of the document and so forth onto the displayed screen in conjunction with the requirements for setting of blanks to be filled, including boxes for the sum of money and date, and the method of remittance from the financial institution handling the document. The completed screen is transmitted back to the document processing system manager 102 (step 403).

(3) When the entry into the screen is completed and the completed screen is sent back at step 403, the document processing system manager 102, prepares a document layout according to the entered items, and presents the draft document layout the document issuer 101. On this occasion, not just one but a plurality of document layout candidates may be presented (steps 404 and 405).

(4) The document issuer 101 reviews on the browser for any problem in the layout candidate or candidates. If any revision is needed, the document processing system manager 102 will be so instructed (steps 406 and 407).

(5) The document processing system manager 102, when instructed to generate any revision, revises the layout accordingly then presents again the revised document layout to the document issuer 101 (steps 408 and 405).

(6) If the review of the layout at step 406 indicates nothing to be revised, the document issuer 101 approves the layout and so notifies the document processing system manager 102 (step 409).

(7) The document processing system manager 102 compiles document processing information on the basis of the approved layout at step 403, then encodes the document processing information into a two-dimensional bar code, and prints the document (steps 410 and 411).

(8) After that, the document processing system manager 102 bills the document issuer 101 for the document generating, and the document issuer 101 pays the document processing system manager 102 for generating the document. In this way, the document generating service is provided (steps 412 and 413).

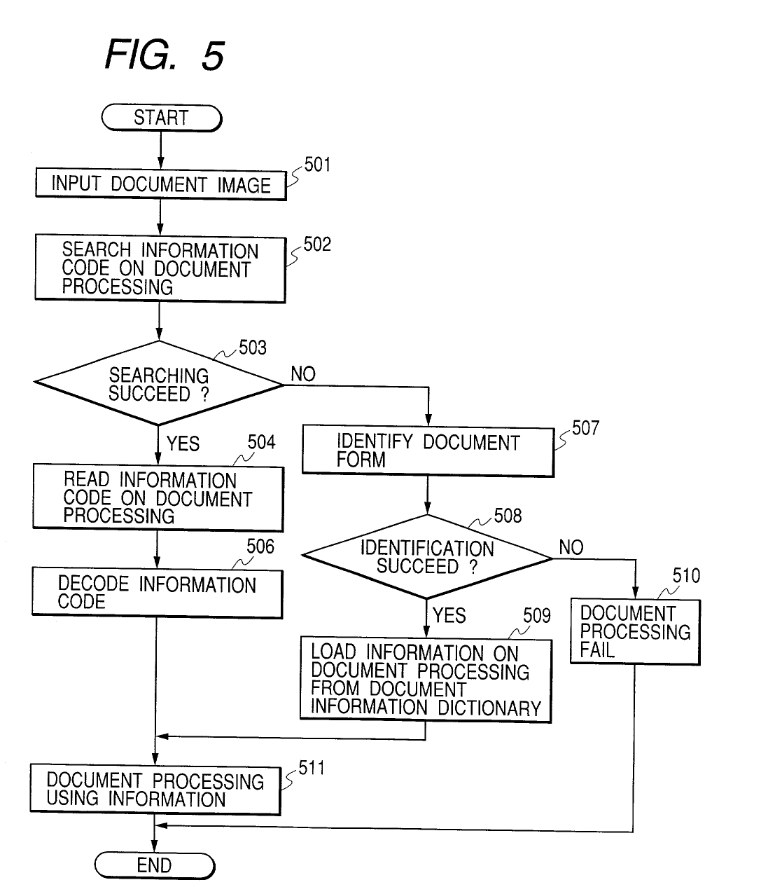

FIG. 5 is a flow chart of document processing in the document processing system within the financial institution. The following description refers to this chart.

(1) First, the document image is read with an optical scanner of the like, followed by detecting the document processing information embedded in the document to decide whether the document processing information has been successfully detected (steps 501 through 503).

(2) If the decision at step 503 indicates a success in detecting the document processing information, the encoded document processing information is read and decoded to obtain the document processing information (steps 504 and 506).

(3) If the decision at step 503 reveals a failure of detecting the document processing information, i.e., the entered document is not made according to the invention. Accordingly, the document is identified by processing similar to the prior art, and the document form of the entered document is thereby obtained (step 507).

(4) It is decided whether the document form/format has been successfully identified. If the document form has been successfully identified, the pertinent document processing information is extracted from the document according to a document processing information dictionary. The document processing information dictionary to be used in extracting the document processing information may be either kept within the document processing system or kept by another system in the network to which the document processing system is linked and referenced via the network (steps 508 and 509).

(5) If the decision at step 508 reveals a failure in identifying the document form, the document form of the entered document will be unknown such that it is impossible to continue the document processing. Therefore, post-processing to follow up a failure in document processing is performed to end the processing here (step 510).

(6) Finally, such aspects of document processing as reading of entered items, posting an acknowledging seal and document cutting are carried out in accordance with the document processing information acquired at step 506 or step 508 to end the document processing (step 511).

In another embodiment of the invention, the document processing system includes input means for reading an embedding medium on a document, document processing information extracting means for extracting document processing information embedded in the embedding medium, document processing means for executing the document processing information which includes at least one document handling procedure, an embedding medium identification means for identifying whether any embedding medium embedded with the document processing information is on the document, and document processing information database retrieving means for retrieving a set of document processing information from a document processing information database of a document provider so as to assign the set of document processing information to the document, if the embedding medium identification means does not identify any embedding medium embedded with the document processing information on the document. The database is stored in the document processing system or in a network to which the document processing system is linked.

Optionally, the document processing system further includes a document processing information defining means for defining a new set of document processing information to be applied to the document if the retrieving means can not retrieve any set document processing information in the database of the document provider. While the set of document processing information is selected from the database based upon a degree of similarity between a document format associated with the set of document processing information and a document image entered through an image input means. The system notifies the document provider the newly-defined set of document processing information so as to be included in the database or to be embedded in other document by the document provider.

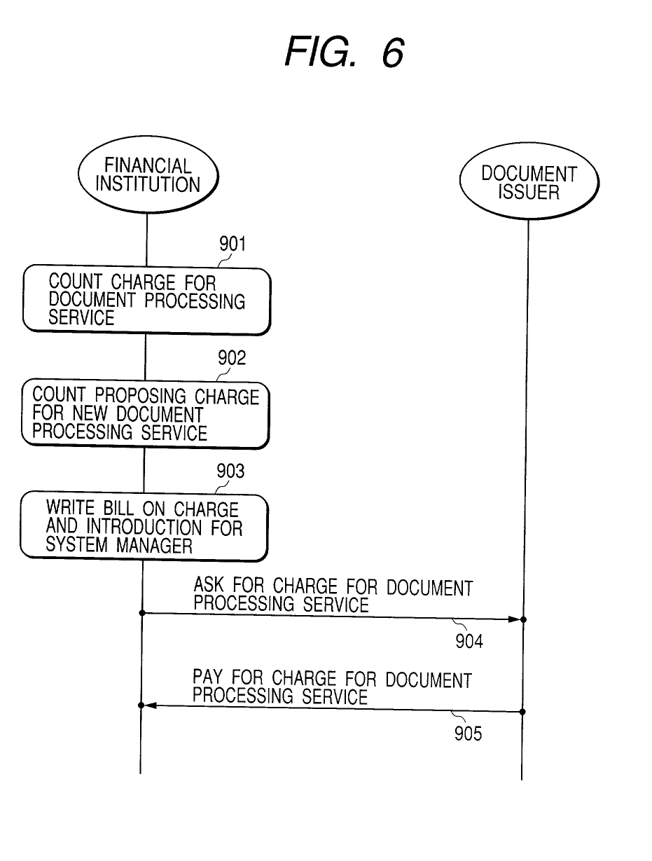

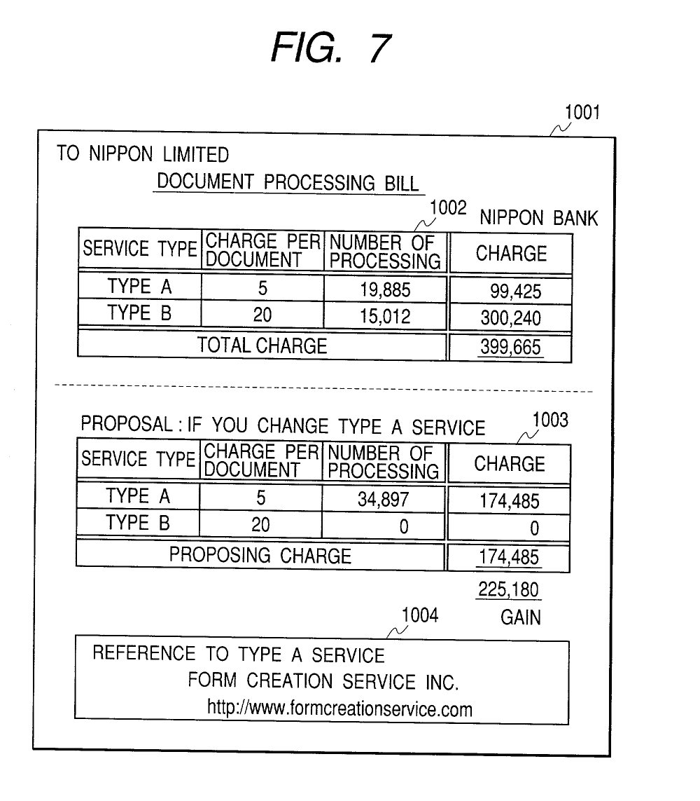

FIG. 6 is a flow chart for the financial institution to request the document issuer to pay the charge for document processing. FIG. 7 illustrates a typical format of the bill. With reference to these figures, the processing for the financial institution to bill the document issuer is described.

(1) First, the financial institution 103 totals the documents issued by the document issuer 101 to be billed, and calculates the sum of the charges. In this process, as indicated in “number of processing” columns 1002 of FIG. 7, the number of Type A documents according to the invention and that of other Type B documents are separately totaled. If the success rate of document processing is reduced by the lower success rates of document identification and of document processing information dictionary completeness, resulting in a failure of document processing, the financial institution will have to rely on manual document processing, and the cost of document processing will increase correspondingly (step 901).

(2) Then the financial institution 103 encourages the document issuer 101 to use documents made according to the invention by setting the service charges for such documents lower than otherwise. For this reason, as shown in a proposal column 1003 of FIG. 7, the financial institution presents the estimated sum of service charges in the case of using documents according to the invention. In the example shown in FIG. 7, the use of documents according to the invention is emphasized by stating the difference between the current sum of charges and the estimated sum according to the proposal (step 902).

(3) Next, the financial institution 103 includes in a bill 1001 the information 1004 of the document system manager 102, including the name, address, telephone number and www address of the document processing system manager 102 (step 903).

(5) After that, the financial institution 103 sends the bill 1001 to the document issuer 101. The bill may be either printed on paper and mailed or sent by e-mail as an electronic file (step 904).

(6) Finally, the document issuer 101 received the bill pays the charge for document processing to the financial institution 103. It can be paid by any available methods, including a bank transfer, currency registration, electronic money, or electronic account settlement (step 905).

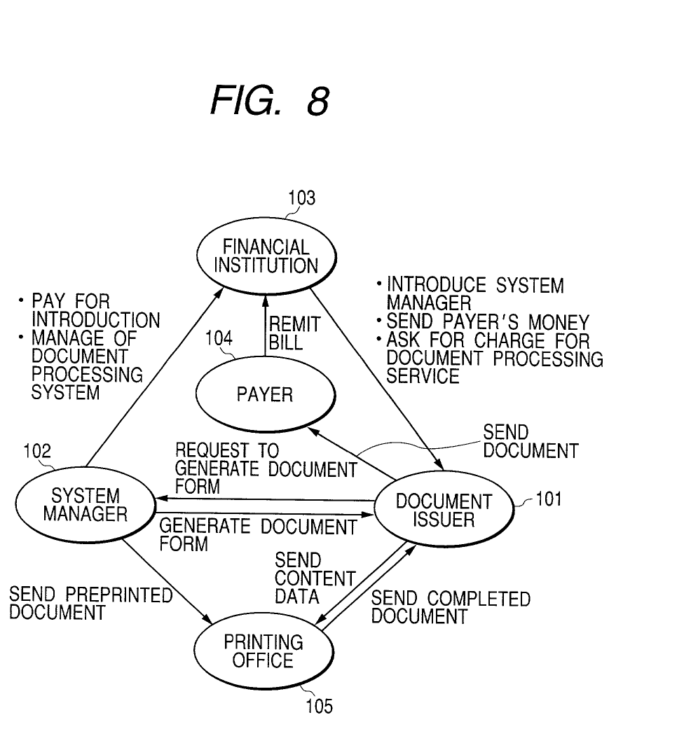

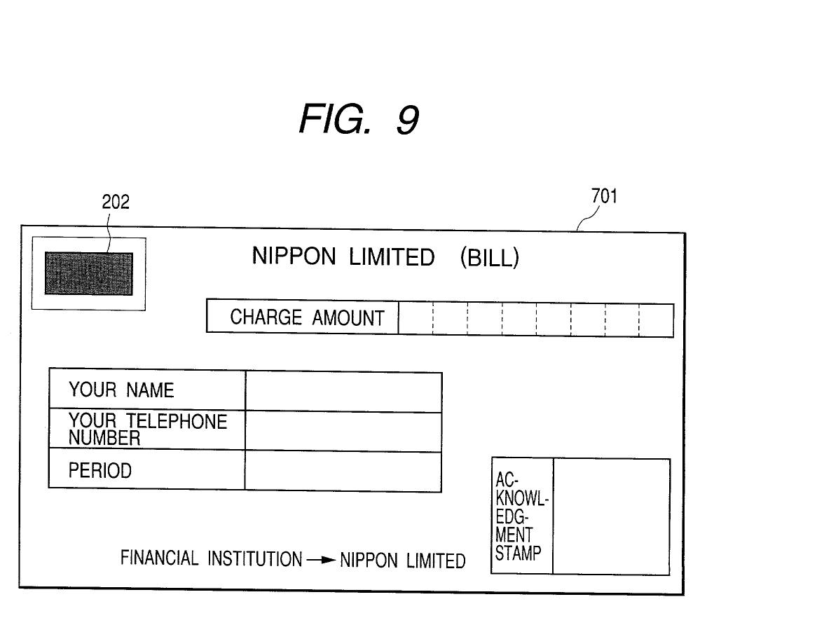

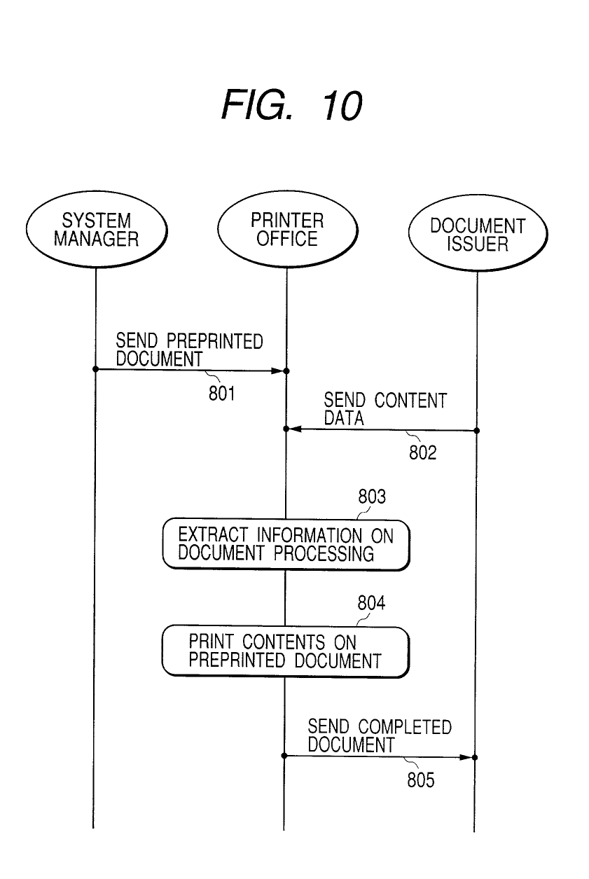

FIG. 8 is a block diagram illustrating a document processing system in a second embodiment for implementing the present invention, FIG. 9 illustrates an example of a preprinted document, and FIG. 10 is a flow chart for printing the documents according to the invention. In FIG. 8 and FIG. 9, reference numeral 105 denotes a printing office, 701 denotes a preprinted document, and other signs denote the same as in FIG. 1 or FIG. 2. In this second embodiment for implementing the invention, as shown in FIG. 8, the required parties concerned include a document issuer 101, a document system manager 102, a financial institution 103 actually taking charge of document processing, a financial institution's client 104 having documents to be processed, and the printing office 105. An additional element in this configuration to the first embodiment for implementing the invention in FIG. 1 is the printing office 105. All the processing takes place in the same way as in the first embodiment for except where the printing office 105 is involved. The basic difference between this second embodiment of the invention and the first embodiment of the invention is the two-stage of document printing, comprising preprinting of the document and printing of document contents.

The document preprinting means prints of common rule marks and character strings in the same document form, including the document title and the document issuer's name. For instance, a preprinted document for the document shown in FIG. 2 may look as shown in FIG. 9. Thus, the preprinted document contains none of the charged sum, personal information, such as the customer's name, and a specific date. Nor does the preprinted document bear contents code information, which is indicated by the string of numerals printed in the document shown in FIG. 2. In this second embodiment of the invention, the document preprinting is performed by the document system manager 102 having prepared the document layout, and the document contents are printed by the printing office 105.

In this case, there may be a plurality of printing offices. Alternatively, the document system manager 102 or the document issuer 101 may function as the printing office.

Next, the processing of printing by the printing office is described with reference to FIG. 10.

(1) First, the document system manager 102 generating the document sends the preprinted document 701 to the printing office 105. If the document system manager 102 concurrently is the printing office 105, this step is omitted (step 801).

(2) On the other hand, the document issuer 101 transmits to the printing office 105 data of the document to be printed. If the document issuer 101 itself is concurrently the printing office 105, this step is omitted (step 802).

(3) Then, the printing office, using an optical scanner or the like, enters the document image of the preprinted document 701 shown in FIG. 9, which is transmitted to the office at step 801, and extracts the two-dimensional bar code 202 having the document processing information stored on the document (step 803).

(4) The printing office, in accordance with the document processing information obtained by decoding the two-dimensional bar code by the processing at step 803, prints on the preprinted document the contents data transmitted at step 802 (step 804).

(5) Finally, the printing office sends the printed document to the document issuer 101. If the document issuer 101 itself is concurrently the printing office 105 or the printing office 105 directly sends the document to the financial institution's client 104, this step is omitted (step 805).

By the above-described processing, the charged sum, personal information, such as the customer's name, a specific date and a numerically expressed contents code are printed on the preprinted document shown in FIG. 7, which results in the kind of document illustrated in FIG. 2.

One of the parties involved in document processing according to the invention, including the document issuer, the document system manager, the financial institution actually taking charge of document processing, the financial institution's client having documents to be processed, and the printing office, at least one of the document system manager, the financial institution and the printing office have information processing systems for performing the various ways of processing described above, is able to provide the processing service via processing programs. These programs can be provided in a storage media as a FD, a CD, a MO or a DVD.

As described, the invention pertains to a document processing method for reading a document image and executing a document handling procedure by extracting document processing information stored in advance on a document and extracting a character string stated on a document in accordance with document processing information.

It also pertains to a document processing method using a document image for payment of a charge, and holding thereon document processing information necessary for document processing. The document processing information includes a document form ID, document form information, such as the name and account number of the document issuer, layout information, such as rule marks and frame positions on the document, and application information, such as a document handling procedure, a document cutting position and an acknowledging seal position. The document processing information is printed in one of such forms as two-dimensional bar code form, text form, one-dimensional bar code form, logo mark, photograph or some other graphic form. Alternatively, the document processing information is written and stored on either a magnetic tape or an IC chip.

It also pertains to a system for determine whether or not any document processing information is present on the entered document and. If no document processing information is present on the entered document, the document processing information is extracted from a document processing information dictionary. It further pertains to a system for differentiating charges for document processing to the document issuer according to whether or not document processing information is stored on the entered document.

The invention provides a document generating method by which a prospective document user wishing to have a document made notifies a document generator of requirements regarding the document layout and the document handling procedure. A document layout is made according to the requirements from the prospective document user. Then the document candidates made by the document layout making means are presented to the prospective document user. The prospective document user selects a document from the document candidates presented, and the document generator stores document processing information on the selected document candidate onto the document.

The invention also pertains to a document printing method by which common rule marks and character strings in the document form are preprinted, and rule marks and character strings different from the document form are printed at the time of printing document contents. The document processing information on the document form is stored onto the document at the time of document preprinting, and the document processing information stored in advance on the preprinted document are extracted at the time of printing document contents. Then the document contents are printed in accordance with the document processing information.

The described invention allows the document issuer to reduce the labor and cost of document generating. The invention also allows the document processing system manager to reduce the trouble in preparing document processing information and maintaining the document processing information dictionary, and to expect an increase in revenue from the document generating service. The invention further allows the financial institution handling documents to reduce the cost of document processing because the documents can be processed with high accuracy.

The foregoing invention has been described in terms of preferred embodiments. However, those skilled in the art will recognize that many variations of such embodiments exist. Such variations are intended to be within the scope of the present invention and the appended claims.

What is claimed is:

1. A method for providing a document along with document processing information thereby processing the document according to the document processing information by embedding the document processing information in the document.

2. A document comprises document processing information embedded in the document for processing of the document according to the document processing information provided according to the method claimed in claim 1.

3. The document as claimed in claim 2, wherein the document processing information is encoded in the document.

4. The document as claimed in claim 2, wherein the document is transmitted through paper delivery, a communication medium, or a telecommunication medium.

5. The document as claimed in claim 2, wherein said document processing information includes operational information including at least one document handling procedure.

6. The document as claimed in claim 5, wherein the document handling procedure is a document cutting step in conjunction with a document cutting position, a seal stamping step in conjunction with a seal stamping position, a document identification step in conjunction with a document ID, a document format identification step in conjunction with a document format ID, an encryption step in conjunction with a encryption key, or a decryption step in conjunction with a decryption key.

7. The document as claimed in claim 2, wherein said document processing information is in at least one of such forms as a two-dimensional bar code, text, an one-dimensional, two-dimensional, or three-dimensional bar code, a logo mark, a photograph, a graphic, a watermark, a holographic, a magnetic tape, or an IC chip.

8. The document as claimed in claim 2, wherein the document is a bill for payment or a commercial paper.

9. A software product comprises a module for providing a document along with document processing information thereby processing the document according to the document processing information provided according to the method claimed in claim 1.

10. A document processing system comprising:
input means for reading an embedding medium on a document;
document processing information extracting means for extracting document processing information embedded in the embedding medium; and
document processing means for executing the document processing information which includes at least one document handling procedure.

11. The document processing system as claimed in claim 10, wherein the input means includes an image input means for reading a document image.

12. The document processing system as claimed in claim 10, wherein the document processing means executes the document handling procedure by reading character strings stated on the document in accordance with the document processing information.

13. The document processing system as claimed in claim 10, the document is a bill for payment or a commercial paper.

14. The document processing system, as claimed in claim 10, further comprising:
an embedding medium identification means for identifying whether any embedding medium embedded with the document processing information is on the document; and
document processing information database retrieving means for retrieving a set of document processing information from a document processing information database of a document provider so as to assign the set of document processing information to the document, if the embedding medium identification means does not identify any embedding medium embedded with the document processing information on the document.

15. The document processing system as claimed in claim 14, said database is stored in the document processing system or in a network to which said document processing system is linked.

16. The document processing system as claimed in claim 14, further comprising a document processing information defining means for defining a new set of document processing information to be applied to the document if the retrieving means can not retrieve any set document processing information in the database of the document provider.

17. The document processing system as claimed in claim 16, wherein the set of document processing information is selected from the database based upon a degree of similarity between a document format associated with the set of document processing information and a document image entered through an image input means.

18. The document processing system as claimed in claim 16, wherein the system notifies the document provider the newly-defined set of document processing information so as to be included in the database or to be embedded in other document by the document provider.

19. The document processing system as claimed in claim 10, comprising a document processing charge billing means for differentiating charges billed to the document issuer according to whether document processing information is stored on the document.

20. A document generating software product, comprising:
a communication module for enabling a prospective document user wishing to have a document made to notify a document generator of requirements regarding a desired document layout and a desired document handling procedure;
a document layout making module for making a document layout according to the requirements from said prospective document user;
a document candidate presenting module for presenting to the prospective document user document candidates made by the document layout making module;
a document selecting module for letting the prospective document user select a document out of the document candidates presented by the document candidate presenting module; and
a document processing information embedding module for enabling said document generator to embed document processing information onto the selected document candidate itself.
